(19) United States
(12) Patent Application Publication
(10) Pub. No.: US 2019/0368235 A1
(43) Pub. Date: Dec. 5, 2019

(54) ANTI-THEFT DEVICE

(71) Applicant: Facultad de Ingenieria - Universidad Nacional de Asuncion, Ciudad San Lorenzo (PY)

(72) Inventors: Eduardo Daniel REDONDO RUIZ DIAZ, Asuncion (PY); Ricardo Matias LOREIRO QUEVEDO, San Lorenzo (PY); Sergio Manuel BRITEZ VALENZUELA, San Lorenzo (PY); Fernando Javier BRUNETTI FERNANDEZ, Asuncion (PY)

(21) Appl. No.: 16/030,260

(22) Filed: Jul. 9, 2018

(30) Foreign Application Priority Data
Jun. 5, 2018 (PY) P 1842744

(51) Int. Cl. E05B 73/00; E05B 47/00; E05B 51/00; E05B 45/06; G07C 9/00

(52) U.S. Cl. CPC E05B 73/00; E05B 73/0082; E05B 47/0001; E05B 2047/0067; E05B 45/06; G07C 9/00563; E05B 51/00

(57) ABSTRACT

The present invention discloses an anti-theft device arranged to secure a user element of the type that comprises: joining means for joining to a support surface with the capacity for separation from said support surface; securing means for securing the element with the capacity for separation from the element; and a controller associated with the securing means for securing to the element; wherein the joining means for joining to the surface and the joining means for joining to the element comprise a suction element, wherein the suctioning of the securing means to the element is controlled by the controller.

### CROSS REFERENCE TO RELATED APPLICATION

This application claims priority of Paraguay Application No. P 1842744 PY filed Jun. 5, 2018, application which is incorporated herein by reference.

### FIELD OF THE INVENTION

The present invention relates to a portable anti-theft device.

Specifically, the present invention discloses a device that enables coupling to different support structures, as well as securing different elements in a way such that they can only be removed from the anti-theft device after user authentication.

### BACKGROUND OF THE INVENTION

It is currently known that the use of laptop computers, smartphones and tablets as a range of technological devices is quite common among the general population; in addition, the variety of portable objects, not necessarily of the electronic type, must be protected, such that the owners or users are able to separate themselves from the same without worrying. Today, there are many anti-theft devices that enable coupling, on one hand, to support structures and, on the other hand, to elements that a user wishes to secure and prevent from being separated from the anti-theft device by unauthorized users, thereby preventing the theft thereof.

One example of this type of device is disclosed in, for example, U.S. Pat. No. 9,500,010. The device disclosed therein is a device that is fastened to a structure by means of intrusive means such as a number of the screws, such that the device is joined to said support structure in a fixed manner. Moreover, the device has a securing element and a locking plate through which a lock can be placed.

The device disclosed in U.S. Pat. No. 9,500,010 has the drawback that by having an intrusive fastening in the support surface, it must have a specific support surface, in other words, a support surface with complementary joining means with respect to the anti-theft device, meaning that the portability thereof is limited to support surfaces with very specific characteristics. Furthermore, in this device the elements to be secured are limited by the size of the device; in general, the anti-theft device is larger than the element to be secured.

Another type of device is disclosed in U.S. Pat. No. 8,061,164. This document discloses a rail for arranging a laptop computer. In this case, the rail joins to a support surface by means of means such as adhesives or screws, and the computer is joined to the rail by means of joining means arranged on the rail (L-shaped projections) and complementary joining means arranged on the computer.

The device of document U.S. Pat. No. 8,061,164, on one hand, thus requires joining by means of intrusive means such as screws and adhesives that are subsequently very difficult to remove and, on the other hand, only functions with apparatuses that have complementary joining means such as, for example, a specific type of computer.

### DESCRIPTION OF THE INVENTION

The present invention discloses a device that solves the problems of the devices of the prior art insofar as it provides greater flexibility with regard to the joining thereof to the support surface and especially, the type of elements that can be secured by the device.

Specifically, the present invention discloses an anti-theft device arranged to secure a user element of the type that comprises:
joining means for joining to a support surface with the capacity for separation from said support surface;
securing means for securing the element with the capacity for separation from the element;
a controller associated with the securing means for securing to the element;
   the joining means for joining to the surface and the joining means for joining to the element comprising a suction element, wherein the suctioning of the securing means to the element is controlled by the controller.

Preferably, the controller controls the suctioning of the securing means between a lock suction and a release suction. Furthermore, the controller can change the suctioning from the lock suction to the release suction as a response to a user input; for example, the device can be in operation so that the joining means for joining to the surface and the securing means for securing the element operate with specific suctioning such that the device remains joined to the surface and it also secures the elements; however, once the user enters a series of data into the controller, the controller reduces the suctioning exerted on the element, releasing it from the device and allowing the user to access it.

In an exemplary embodiment, the user input is an input of a code into a keyboard, an input by means of radio frequency and/or an input of a biometric parameter.

In a particular embodiment, the device has a plurality of securing elements, such that it can secure larger elements or even secure a plurality of elements. Furthermore, the controller can have control means for each securing element, such that it can selectively reduce the required securing means.

With regards to the suction elements, these elements can be, for example, suction pads, suction cups and/or piezoelectric vacuum pumps.

Preferably, the controller has an alarm to indicate the loss of suction in the suction elements. Thus, it can be determined whether suctioning with the support surface is failing and/or whether the devices are properly secured.

Furthermore, the device of the present invention can have adherence sensors for the joining means and/or the securing means.

In an especially preferred embodiment, the device comprises a front face which has securing means and a rear face, opposite the front face, which has joining means.

### BRIEF DESCRIPTION OF THE DRAWINGS

An exemplary embodiment of the present invention, which should be interpreted in a non-limiting manner, is shown below by means of the figures. The following figures are not to scale. The true dimensions for each of the components may vary according to the needs of the user. The most significant details of the device are shown so that a person with no expertise in the subject matter can clearly see the object.

FIGS. 1A-1C show an exemplary embodiment of an anti-theft device according to the present invention.

FIG. 2 shows a perspective view of the device of FIGS. 1A-1C.

FIG. 3 shows an exemplary embodiment of a device according to the present invention with the capacity to modify the dimensions thereof.

FIG. 4 shows a device that can be disassembled according to an embodiment of the present invention.

FIG. 5 schematically shows the components of a device according to the present invention.

FIG. 6 shows a side view of an example of the device according to the present invention.

FIG. 7 shows a front view of another example of the device according to the present invention.

FIG. 8 shows a schematic diagram of the electronic components of an example of the device according to the present invention.

### DETAILED DESCRIPTION OF AN EMBODIMENT

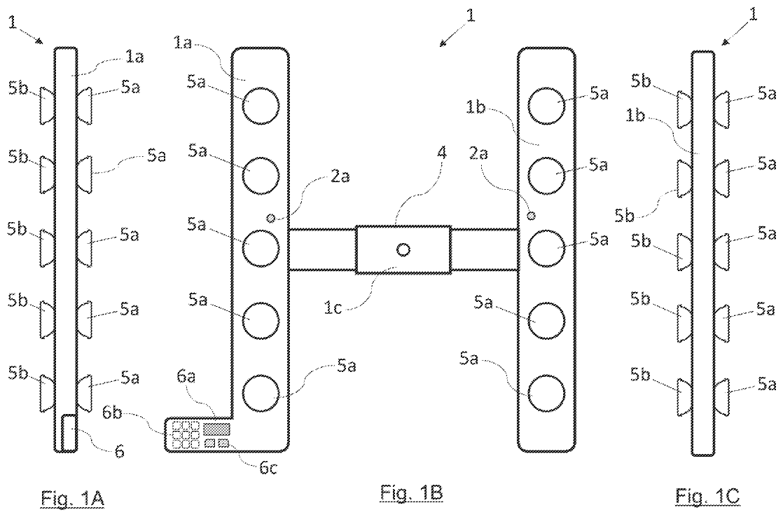

FIGS. 1A-1C show an exemplary embodiment of the present invention. FIG. 1A shows a side view, FIG. 1B shows a front view and FIG. 1C shows the other side view of an example of the anti-theft device (1) according to the present invention.

This example of the device (1) shows that it comprises two longitudinal bases (1a, 1b) joined by a transverse base (1c) wherein the first longitudinal base (1a) has a controller (6) intended to control at least part of the device (1).

Each longitudinal base (1a, 1b) has a number of securing means (5a) on the front face thereof intended to receive at least one user element to prevent the removal thereof from the device (1) by unauthorized people. Moreover, the longitudinal bases (1a, 1b) have a number of joining means (5b) on the rear face thereof arranged to fasten the device (1) to a support surface, such that they keep the anti-theft device (1) fixed to said support surface.

In the example of FIGS. 1A-1C, both the securing means (5a) and the joining means (5b) are elements based on suctioning for adhering external elements to the device (1). In the case of the securing means (5a) for adhering, with the capacity for separation, to a user element or apparatus, and in the case of the joining means (5b) for joining, with the capacity for separation, to a support surface. This characteristic of having joints with the capacity for separation is especially useful in the device (1) of the present invention insofar as it provides the device (1) with portability that the devices of the prior art do not have; in other words, a user can carry it and they have the ability to use it on a wide range of support surfaces and remove it to use it again. Furthermore, it can join to a wide range of devices that can only have a substantially flat surface larger than the securing means (5a). In this case, said joining means and securing means are means based on suctioning, for example, suction cups. Alternatively, in the present invention the use of piezoelectric vacuum pumps and/or vacuum cups is envisaged.

To be able to determine the presence of elements to be secured by the device (1), the device (1) can have presence sensors (2a). Preferably, the device (1) will have a number of presence sensors, for example, in the vicinity of at least some of the securing means (5a). Examples of said presence sensors can be, for example, optical sensors. Furthermore, the device (1) can also have presence sensors in the rear face thereof to determine the presence of a support surface.

Said presence sensors can be used as alerts since, if the device (1) determines that there are no elements (detected by means of the presence sensors on the front face), an alert can be activated informing the user of the removal of the elements. Furthermore, if there are no support surfaces (detected by means of the presence sensors of the rear face), an alert can be activated informing the user of incorrect joining or that the device (1) has been separated from the support surface without authorization.

FIGS. 1A and 1B show that the device (1) has a controller (6). Said controller has a screen (6a) that can be a touch screen, a numeric keyboard (6b) and/or lock/unlock keys (6c). The operation is that in which the user has the device (1) with joining means (5b) on a support surface and moreover, an element to be secured is arranged on the securing means (5a). Subsequently, by means of the controller (6), it configures the support means and/or joining means so that they provide adherence to the joining and securing means. The controller, as a result, issues a signal to a series of controllers associated with the joining and securing means to increase adherence. Thus, the element to be secured is kept fixed to the support surface using the device (1) as an intermediary. When it is necessary to remove the element and/or the anti-theft device (1), the user enters a command into the controller (6) and the controller decreases adherence with the element and/or the support surface, as the case may be.

In addition to the screen, the keyboard and the lock/unlock keys, the controller can be provided with biometric detection elements such as fingerprint readers, cameras, etc. to authenticate the user and give them control over the joining and securing means.

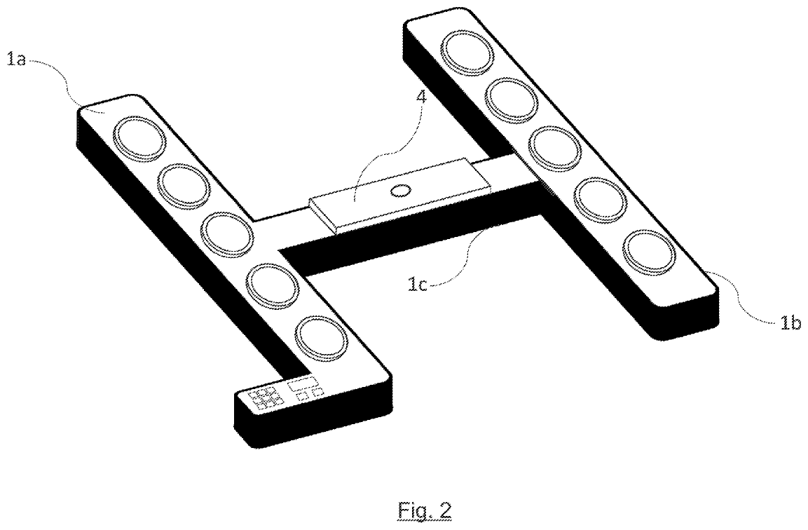

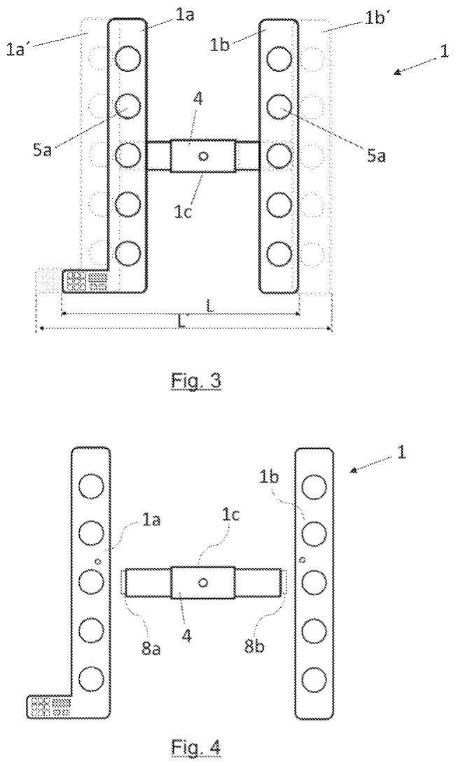

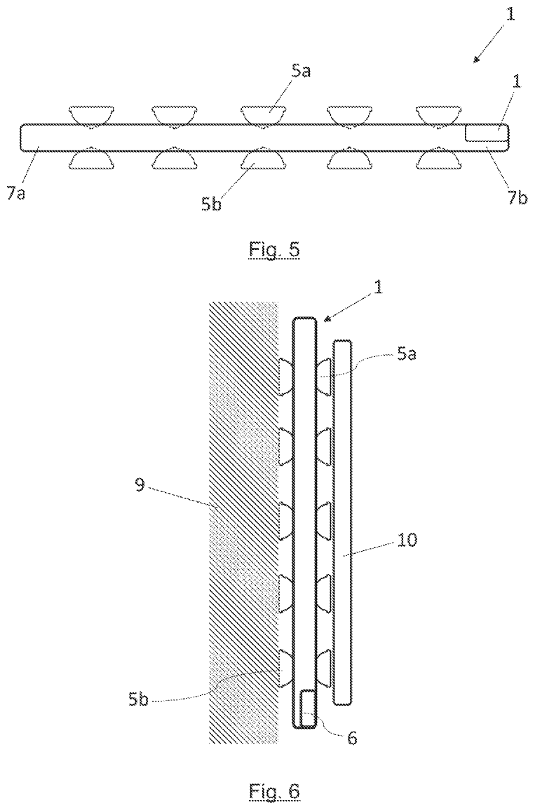

FIG. 2 shows a perspective view of the device of FIGS. 1A-1C. In this figure, the presence of the joining means (5a), as well as that of the controller (6) can be seen in greater detail. Moreover, it is observed that an interconnecting mechanism (4) can be arranged on the transverse base (1c) intended to adjust the structure of the device (1) according to the needs of each case and which will be explained in greater detail referring to FIGS. 3 and 4.

FIG. 3 shows how the interconnecting mechanism (4) can have means for the modification of the width of the device (1). In a first configuration, the device (1) has a first width (L) defined by the maximum distance of separation between the longitudinal bases (1a, 1b), while in a second configuration, the device (1) has a second width (L′) defined by the distance of separation between the extended bases (1a′, 1b′). To achieve this separation, the interconnecting mechanism (4) has extending means, for example, telescopic extending means.

This characteristic enables the user to configure the device (1) according to their needs; for example, if greater stability of the device (1) and an increase in the effective surface that it occupies are needed, the user can use it with the extended bases (1a′, 1b′) thereof, whereas if it requires a more compact configuration, for example, meaning that it has little space on the support surface, the unextended bases can be used.

FIG. 4 shows another embodiment of the device (1) of the present invention wherein the transverse base (1c) has connecting means (8a, 8b) to the longitudinal bases (1a, 1b). In the case of FIG. 4, said connecting means (8a, 8b) can be coupled and uncoupled and they enable only one of the bases of the device (1) to be used in the case in which the complete structure is not required, due to the fact that there is a desire to secure a smaller element and/or there is little space on the support surface. Said connecting means (8a, 8b) can have mechanical couplings and electrical couplings.

FIG. 5 shows a schematic side view of an example of the device according to the present invention.

From an operational point of view, the device (1) of the present invention can have, on one hand, a controller (6) that can be any combination between hardware and software configured to execute a series of instructions and, on the other hand, a first actuator (7a) associated with the securing means (5a) and a second actuator (7b) associated with the joining means (7b).

Specifically, the actuators are devices suitable for configuring the adherence of the joining means (5b) and/or the securing means (5a). Specifically, said actuators control the suctioning exerted by said joining and/or securing means and they are in communication with the controller (6) that defines the adherence that they must have at all times.

In the particular embodiment in which the joining or separating means are a number of securing means, the actuator can have action means in each one of said number of means independently. Thus, if there is a desire to put an apparatus on each securing element, the user can select the element that they wish to remove from the device (1) and the controller only reduces the degree of adherence of the securing elements associated with said apparatus.

FIG. 6 shows a preferred embodiment of the present invention wherein the device (1) joins to a support surface (9) to secure a user apparatus (10) and prevent the theft or unauthorized removal thereof.

The example of FIG. 6 shows how the securing means (5a) hold an apparatus (10) of a size that substantially occupies all the securing means (5a); however, the device (1) can be configured to hold several smaller apparatuses occupying fewer of said securing means (5a), and in particular, an apparatus for each one of said means.

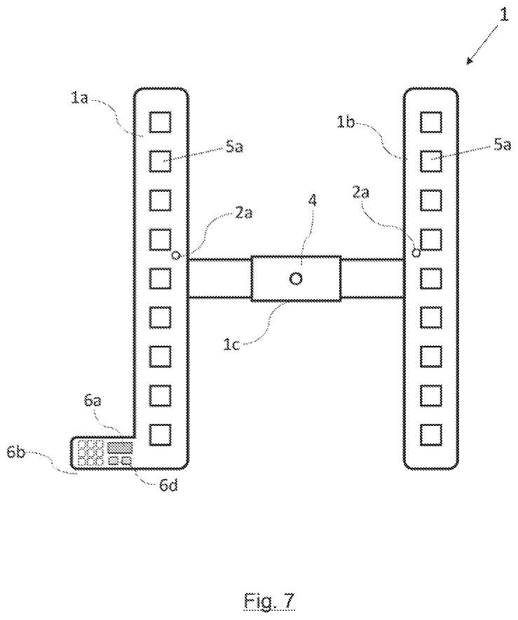

FIG. 7 shows another exemplary embodiment of an anti-theft device (1) according to the present invention. Specifically, FIG. 7 shows a particular embodiment wherein the securing means (5a), and optionally, the joining means (not shown) can be piezoelectric vacuum pumps, instead of the vacuum cups of FIGS. 1-6.

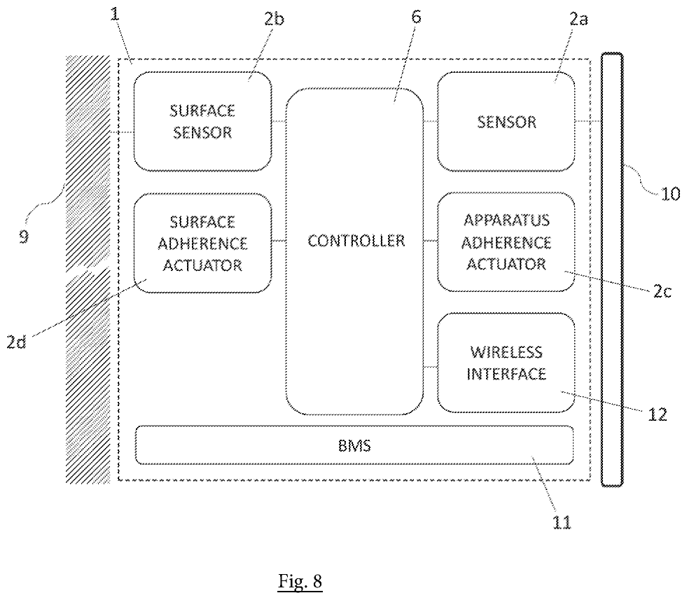

FIG. 8 shows a schematic diagram with an emphasis on some of the electronic components that can comprise an anti-theft device (1) according to the present invention.

Specifically, the device (1) of FIG. 1 has an apparatus presence sensor (2a) to determine whether there are apparatuses (10) or elements that are close to the device; furthermore, it has a surface presence sensor (2b) to determine whether there is a support surface (9) close to the device. In an especially preferred embodiment, the apparatus presence sensor (2a), along with the securing means (not shown), and the surface presence sensor (2b), along with the joining means (not shown), are arranged on opposite faces of the device (1).

Furthermore, the device (1) has apparatus actuators (2c) associated with the securing means (not shown), as well as surface actuators (2d) associated with the support surface (9), said actuators being suitable for controlling the adherence of the joining means and the securing means, respectively. Said actuators are controlled by the controller (6) which, depending on the user inputs, defines which adherence each joining means and/or securing means must have and sends the corresponding control signals to the actuators (2c, 2d).

Lastly, the device (1) has other accessories such as, for example, a wireless interface (12) for wireless communication with the user, such that the user can send commands to the controller or receive signals such as, for example, alerts generated from the signals of the presence sensors (2a, 2b). Another accessory can be a battery management system (11) responsible for managing the energy of the device (1).

1. An anti-theft device arranged to secure a user element of the type that comprises:
joining means for joining to a support surface with the capacity for separation from said support surface;
securing means for securing the element with the capacity for separation from the element; and
a controller associated with the securing means for securing to the element;
wherein the joining means for joining to the surface and the joining means for joining to the element comprise a suction element, wherein the suctioning of the securing means to the element is controlled by the controller.

2. The device according to claim 1, wherein the controller controls the suctioning of the securing means between a lock suction and a release suction.

3. The device according to claim 2, wherein the controller changes the suctioning from the lock suction to the release suction as a response to a user input.

4. The device according to claim 3, wherein the user input is an input of a code into a keyboard, an input by means of radio frequency and/or an input of a biometric parameter.

5. The device according to claim 1, further comprising a plurality of securing means.

6. The device according to claim 5, wherein the plurality of securing elements is arranged to secure a plurality of elements.

7. The device according to claim 5, wherein the controller has control means for each securing element.

8. The device according to claim 1, wherein the suction elements comprise suction pads, suction cups and/or piezoelectric vacuum pumps.

9. The device according to claim 1, wherein the controller has an alarm to indicate the loss of suction in the suction elements.

10. The device according to claim 1, further comprising adherence sensors of the joining means.

11. The device according to claim 5, further comprising adherence sensors of the joining means.

12. The device according to claim 1, further comprising a front face which has securing means and a rear face, opposite the front face, which has joining means.
